(19) United States
(12) Patent Application Publication
(10) Pub. No.: US 2023/0290157 A1
(43) Pub. Date: Sep. 14, 2023

(54) METHOD AND APPARATUS FOR PREDICTING VIRTUAL ROAD SIGN LOCATIONS

(71) Applicant: Harman International Industries, Incorporated, Stamford, CT (US)

(72) Inventors: Dmitry Aleksandrovich Yashunin, Nizhny Novgorod (RU); Roman Dmitrievich Vlasov, Zavolzhie, Nizhny Novgorod reg. (RU); Andrey Viktorovich Filimonov, Bogorodskiy rayon (RU)

(21) Appl. No.: 18/007,037

(22) PCT Filed: Jul. 31, 2020
(86) PCT No.: PCT/RU2020/000402

§ 371 Date: Jan. 26, 2023

(51) Int. Cl. G06V 20/58; G06V 20/56; G06V 20/13

(52) U.S. Cl. CPC G06V 20/582; G06V 20/13; G06V 20/588

(57) ABSTRACT

Provided are a computer-implemented method and apparatus for predicting virtual road sign locations of virtual road signs that may be superimposed onto environmental data of a vehicle. The method includes collecting, as a first training data subset, one or more aerial and/or satellite images of a pre-determined region; obtaining, as a second training data subset, geocentric positions of key point markers in the pre-determined region; supplying the first and second training data subsets to a deep neural network as training dataset; training the deep neural network on the training dataset to predict key point marker locations in a region of interest, the key point marker locations corresponding to virtual road sign locations; defining a region of interest as input dataset; and processing the input dataset by the trained deep neural network to predict key point marker locations within the defined region of interest.

### FIELD

The present disclosure relates to a computer-implemented method and an apparatus for predicting virtual road sign locations where virtual road signs may be superimposed onto environmental data for display in, for example, a navigation system of a vehicle.

### BACKGROUND OF THE INVENTION

In augmented reality navigation systems data of the physical environment of a vehicle is typically overlaid with information from a digital road database stored in the navigation system. The physical environment of the vehicle is usually captured as scene images by a forward-facing camera that is arranged at the vehicle, the scene images being output as environmental data to the navigation system. On the display of the navigation system the driver then sees the scene images superimposed with additional, augmenting information/content such as virtual road signs, maneuver prompts, or other navigation instructions.

However, especially with complicated intersections it is often difficult to accurately place the augmenting information in relation to the displayed scene image. Inconsistencies might occur between the location of the augmenting information and the displayed scene image.

### SUMMARY

The present disclosure relates to a computer-implemented method for predicting virtual road sign locations. The method comprises the following steps: collecting, as a first training data subset, one or more aerial and/or satellite images of a pre-determined region; obtaining, as a second training data subset, geocentric positions of key point markers in the pre-determined region; supplying the first training data subset and the second training data subset to a deep neural network as training dataset; training the deep neural network on the training dataset to predict key point marker locations in a region of interest, the key point marker locations corresponding to virtual road sign locations; defining a region of interest as input dataset; and processing the input dataset by the trained deep neural network to predict key point marker locations within the defined region of interest, the key point marker locations corresponding to virtual road sign locations.

The steps of the method may be performed in the mentioned order. The predicted key point marker locations may be used for superimposing onto environmental data (e.g., scene images) displayed to a driver of a vehicle, the environmental data being output by a forward-facing camera of the vehicle. The predicted key point marker locations may be stored in a database. In this way a database of key point marker locations may be obtained that may be updated periodically by periodic execution of the method. The database may, for example, be stored in a vehicle’s on-board navigation system such that an augmented navigation application can use the predicted key point marker locations to superimpose virtual road signs onto a displayed scene image to assist in driving maneuvers. The database of predicted key point marker locations may be used to superimpose key point markers in the form of virtual road signs onto a standard definition (SD) map, thereby avoiding the use of larger high definition (HD) maps that use more memory space.

The aerial and satellite images may be map tiles of earth images, in particular map tiles containing road infrastructures such as, e.g., intersections. The key points may, for example, include turn points and/or line-change locations/signs.

The method comprises a training phase and an inference phase. The training phase includes the steps of collecting the first training data subset, obtaining the second training data subset, supplying the first training data subset and the second training data subset as training dataset to a deep neural network, and training the deep neural network on the training dataset to predict key point marker locations in a region of interest. The inference phase includes the steps of defining a region of interest as input dataset, and processing the input dataset by the trained deep neural network to predict key point marker locations within the defined region of interest. The inference phase may further include the step of storing the key point marker locations in a database.

With the second training data subset, e.g., the geocentric positions of the key point markers in the pre-determined region, the first training data subset, e.g., the aerial and/or satellite images of the pre-determined region may be labeled (also called marked-up), wherein the labels are the geocentric positions/locations of the key point markers. For example, if the key points are turn points, the labels are the geocentric positions, e.g., the coordinates, in particular the degrees of longitude and latitude, of the turn points within the entire set or a subset of the intersections and crossroads in the aerial and/or satellite images.

The geocentric positions of the key point markers may be obtained, for example, through user input, through one or more crowdsourcing platforms, and/or through provision of established geocentric positions of key point markers in the pre-determined region. This list of options for obtaining geocentric positions of key point markers shall not be exhaustive. In case the geocentric positions of the key point markers are obtained through user input, people/users may be asked to enter labels indicating geocentric positions of key point markers in the pre-determined region into a specifically designed computer system that may be configured to display aerial and/or satellite images of pre-determined regions. In case the geocentric positions of the key point markers are obtained by provision of established geocentric positions of key point markers in the pre-determined region the established geocentric positions of the key point markers may be bought from a provider already having the sought after geocentric positions of the key point markers.

The deep neural network may be a convolutional neural network. During the training of the deep neural network, the weights of the deep neural network are set such that the deep neural network starts predicting, for the region of interest being the pre-determined region used during training, key point marker locations as close as possible to the locations of the key point markers included in the second training data subset.

The deep neural network may predict the key point marker locations, e.g., the virtual road sign locations, such that, for an intersection, the key point markers are located at the center of each road or lane entering the intersection. Intersections may comprise crossroads, T junctions and similar. The deep neural network may also predict the key point marker location such that the key point markers, e.g., the virtual road signs, have superior visibility, e.g., are not occluded by environmental objects such as buildings or the like.

The method of the present disclosure, e.g., its training phase and also its inference phase, may be performed offline, e.g., not in real-time but in an offline modus. Specifically designed servers with appropriate computational resources may be used. In offline processing the region of interest that serves as input data for the deep neural network in the inference phase may be defined in advance. In case of offline processing the predicted key point marker locations may be stored in a database for further distribution to mobile devices such as smart phones and vehicle navigation systems, where virtual road signs are superimposed at the predicted key point marker locations onto the scene images captured, e.g., by a forward-facing camera of the vehicle. If desired a coordinate transformation may be performed on the predicted key point marker locations such that the coordinate system used for the key point marker locations is transformed into the coordinate system used for the pixels of the scene images.

In the offline modus a feedback/validation mechanism may be provided to ensure that the trained deep neural network properly predicts the key point marker locations. A separate, second neural network may be provided to which the aerial and/or satellite images of the pre-determined region that were used as first training data subset are supplied as input data for validation. The second neural network analyses the validation input data and detects intersections in the pre-determined region/the first training data subset. It is then further checked by comparison whether the key point marker locations predicted by the trained deep neural network coincide with the detected intersections or not. A tolerance range may be provided allowing for some distance between the predicted key point marker locations and the detected intersections. If the predicted key point marker locations do not coincide with the detected intersections, then the pre-determined region concerned is marked for manual labeling (e.g., by placing it in a corresponding queue), e.g., for manually assigning one or more key point marker locations to the intersections concerned. After manual labeling the pre-determined region may be used the next time the trained deep neural network is applied to the pre-determined region.

Alternatively, the inference phase of the method may be performed online (online modus), for example on a mobile device such as a smart phone or a navigation system used in a vehicle, as the mobile device travels along the route together with the vehicle. In this case the regions of interest may be defined in real-time, for example by the driver. E.g., the input dataset to the trained deep neural network is supplied to and processed by the trained deep neural network in real-time. In case of online processing the predicted key point markers may be immediately used in that virtual road signs are superimposed in real-time on the scene images captured by a forward-facing camera of the vehicle at the predicted key point marker locations. The predicted key point markers are selected for superimposing based on the current position of the vehicle and route information such that key point markers relevant to the current route are selected. Again, a coordinate transformation may be performed on the predicted key point marker locations such that the coordinate system used for the key point marker locations is transformed into the coordinate system used for the pixels of the scene images, if desired.

In the online modus, if a key point such as a turn point or a line change possibility are displayed by the navigation system of a vehicle, but there is no virtual road sign superimposed, or a displayed virtual road sign is placed unacceptable far away from the key point, this may be detected by a feedback/validation mechanism of the method (or by user input). In this case the location, e.g., the coordinates, of the key point and the location, e.g., the coordinates, of the misplaced virtual road sign/predicted key point marker (if there is any) may be uploaded together with a tolerance range to a server or similar for further analysis. If an error is found in the database of predicted key point marker locations during the analysis, the missing key point marker will be placed manually, e.g., its location will be chosen manually, and used the next time the trained deep neural network will be used for the same region of interest.

The present disclosure further relates to an apparatus for predicting key point marker locations that shall be superimposed onto environmental data of a vehicle, wherein the apparatus comprises means for performing the method of the present disclosure. For example, the apparatus comprises a processor and a memory that may be employed for the training phase and the inference phase of the deep neural network. The trained deep neural network and/or the predicted key point marker locations, e.g., the predicted road sign locations, that are generated by the deep neural network may be stored in the memory.

The method of the present disclosure exploits the fact that aerial and satellite images of the earth include road infrastructures which contain information such as, e.g., intersections, that can be used to define key point marker locations. With the method key point markers/virtual road signs that may be accompanied by additional augmenting content (e.g., the name of a diverting street at an intersection) may be placed properly in relation to their corresponding key points, e.g, intersections, in a displayed scene image so that a driver of a vehicle, navigation applications and/or autonomous path planning systems can effectively execute driving maneuvers.

The present disclosure may be applied to so-called augmented navigation systems as used in vehicles but is not limited to this particular application. The present disclosure may, for example, be applied to any computer system that uses a display such as a computer screen or other means of visualization where navigation instructions such as virtual road sign shall be superimposed onto real-world images taken, for example, by a forward-facing camera.

### BRIEF DESCRIPTION OF THE DRAWINGS

Embodiments are described by way of example, with reference to the accompanying drawings, which are not drawn to scale, in which like reference numerals refer to similar elements.

FIG. 1 illustrates an example augmented navigation system placed in the front of a vehicle;

FIG. 2 illustrates a scene image displayed on an augmented navigation system augmented with turn point marker and further navigation content/information;

FIG. 3 illustrates an example training dataset (training input data) for a deep neural network of the present disclosure (left-hand side), and corresponding key point marker locations predicted by the trained deep neural network of the present disclosure (right-hand side);

FIG. 4 illustrates an example of predicted key point marker locations indicated in environmental data;

FIG. 5 illustrates a further example of predicted key point marker locations indicated in environmental data;

FIG. 6 illustrates an example of a deep neural network employed in the present disclosure; and

FIG. 7 illustrates a flow diagram of an embodiment of a method for predicting virtual road sign locations.

### DETAILLED DESCRIPTION OF THE PREFERRED EMBODIMENTS

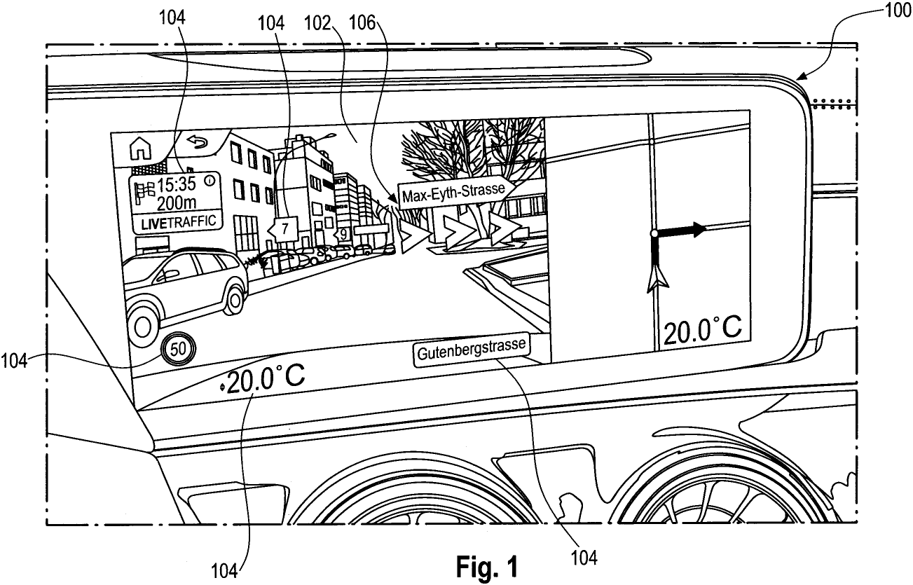

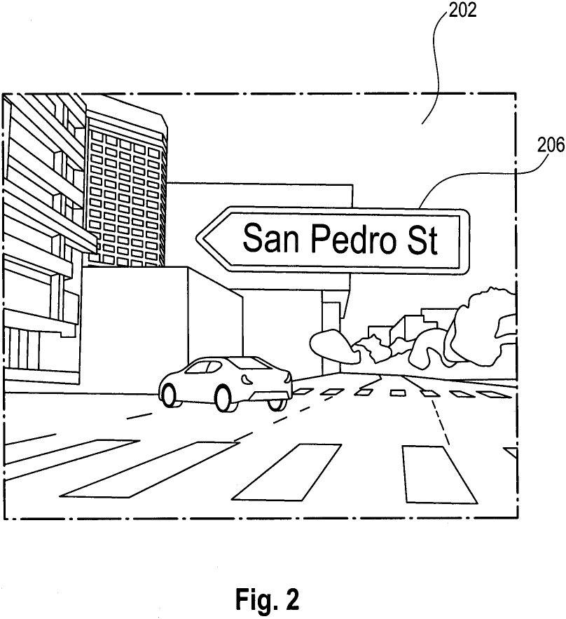

FIG. 1 shows an example of an augmented navigation system 100. On the display of the augmented navigation system 100 a scene image 102 is shown that has been captured, for example, by a forward-facing camera (not shown) that is installed on the vehicle. The scene image 102 is overlaid with additional information/content 104, 106 such as maximum velocity, current temperature, current time and distance to destination, location of the destination (street number “7”), name of the street currently travelled on, and the next diverting street combined with a turn point marker 106. The turn point marker 106 represents a virtual road sign. FIG. 2 shows a further example of a (portion of a) display of an augmented navigation system wherein the shown scene image 202 is augmented with a turn point marker 206 in form of a virtual road sign indicating a left turn.

The turn point markers 106, 206 shown in FIGS. 1 and 2 represent key point markers marking key points on a travel route of a vehicle. On the key points the driver may wish to perform a driving maneuver such as taking a right or left turn, or changing lanes. A key point marker, e.g., a virtual road sign or a virtual line change sign, superimposed onto the scene image shall help the driver in making maneuvering decisions. The key point markers are bound to specific locations, e.g., the key points, within the physical environment of the vehicle, and have therefore known geocentric coordinates, in particular known degrees of latitude and longitude.

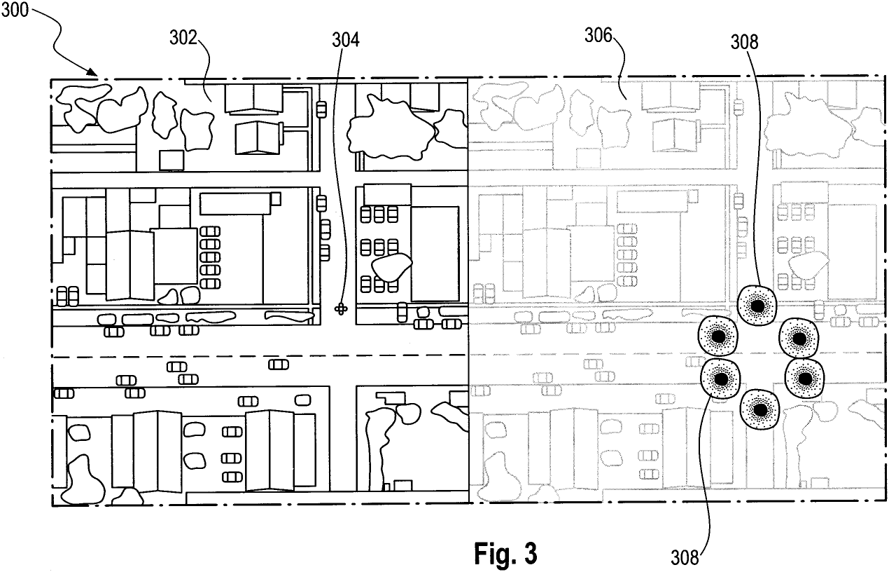

FIG. 3 shows on its left-hand side an example training dataset 300 used as input to the deep neural network employed in the present disclosure. The training dataset 300 includes an aerial or satellite image 302 of a pre-determined region as first training data subset and geocentric positions 304 of key point markers in the form of turn point markers within the pre-determined region. On its right-hand side of FIG. 3 example output data generated by the trained deep neural network in the inference phase is depicted. The region of interest 306 represents the input dataset to the trained deep neural network in the inference phase and may be supplied to the trained deep neural network, for example, as aerial or satellite image. For the region of interest 306 the trained deep neural network infers and thus predicts the key point marker locations 308 corresponding to virtual road sign locations. The key point marker locations 308 correspond in this example to turn point locations placed in the center of a lane or road.

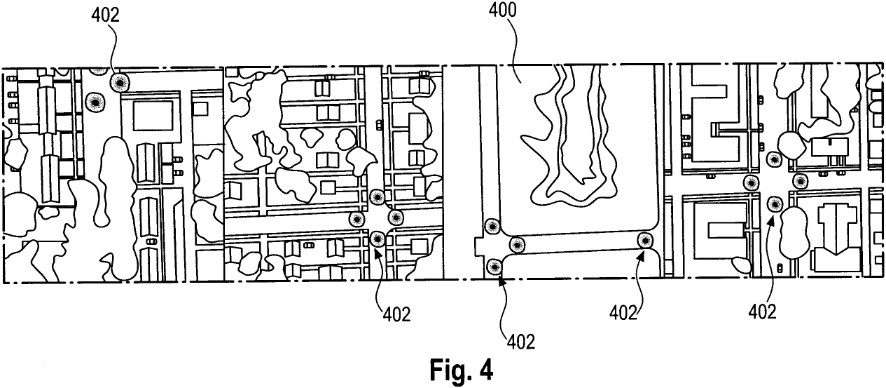

FIG. 4 shows an example of key point marker locations 402 that have been predicted by the deep neural network of the present disclosure in a region of interest 400 which was supplied to the trained deep neural network as input data during inference. As in FIG. 3, right-hand side, the predicted key point marker locations 402 represent turn point marker locations at intersections such as crossroads or T junctions, and may be positioned in the center of a lane or road entering an intersection.

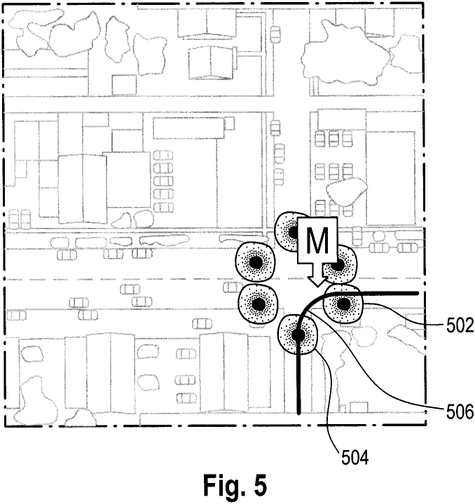

The key point marker locations may also be predicted such by the trained deep neural network that the key point markers are positioned on a curved path connecting two adjacent potential key point marker locations at road/lane centers. In this case, the key point marker locations (e.g., the visual road sign locations) may be chosen such on the curved path that the key point markers/virtual road signs are more visually appealing/better visible/better discernable to a driver, for example, not occluded by a building but instead placed before the building. An example is shown in FIG. 5 where two adjacent potential key point marker locations 502 and 504 are connected by a curved path 506 on which the key point marker M, i.e, the virtual road sign, is then placed such that it can be better or easily perceived by a driver than if the key point marker were to be placed at locations 502 or 504.

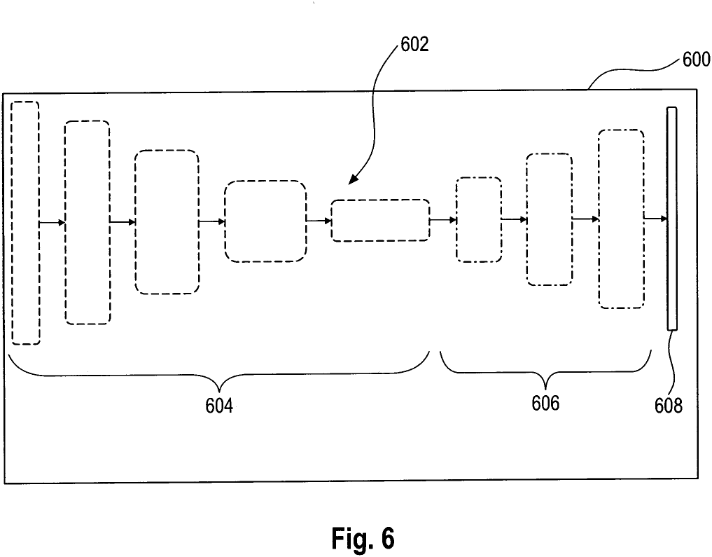

FIG. 6 shows an example of a deep neural network of the present disclosure. The deep neural network may be a convolutional neural network 602 that may be trained and, after training, stored in an apparatus 600 of the present disclosure. The convolutional neural network 602 may comprise a multitude of convolution blocks 604, a multitude of deconvolution blocks 606 and an output layer 608. Each block may comprise several layers. During training the training dataset is supplied to the first one of the convolution blocks 604. During inference the input dataset, e.g. the defined region of interest, is supplied to the first one of the convolution blocks 604. The convolution blocks 604 and the deconvolution blocks 606 may be two-dimensional. The deconvolution blocks 606 followed by the output layer 608 may transform the final output data of the convolution blocks 604 into the output dataset (output predictions) that is then output by the output layer 608. The output dataset includes the predicted key point marker locations, e.g., the predicted virtual road sign locations. The output dataset of the convolutional neural network 602 may be given by a pixel map of possible intersections in the pre-determined region (training phase) or in the defined region of interest (inference phase) with a probability value (probability score) associated with each pixel. Those pixels for which the probability score is high, e.g., exceeds a predefined threshold (for example, 90% (0.9)), are then identified as predicted key point marker locations.

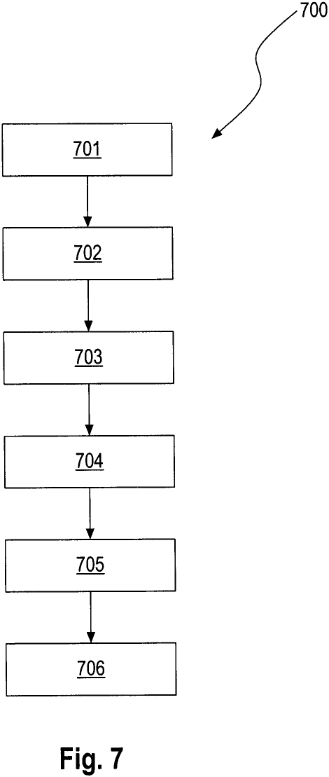

FIG. 7 shows a flow diagram 700 of an embodiment of the method of the disclosure. In step 701 aerial and/or satellite images of a pre-determined region are collected as a first training data subset for a deep neural network. In subsequent step 702 geocentric positions of key point markers, for example turn point markers and/or line change markers, in the pre-determined region are obtained as second training data subset. The ordering of steps 701 and 702 may be exchanged. Steps 701 and 702 may also be performed in parallel. In subsequent step 703 the first training data subset and the second training data subset are supplied to the deep neural network as training dataset. Then, in subsequent step 704 the deep neural network is trained on the training dataset such that it predicts key point marker locations in the pre-determined region and, hence, in a region of interest. The key point marker locations correspond to, are in particular identical to, virtual road sign locations of virtual road signs that may be superimposed on scene images captured by a forward-facing camera of a vehicle. Steps 701 to 704 constitute the training phase of the deep neural network. After step 704 the inference phase of the method begins. In step 705 that follows step 704 a region of interest is defined, for example by a driver, as input dataset for the trained deep neural network. In subsequent step 705 the input dataset is processed by the trained neural network to predict key point marker locations, in particular turn point marker locations and line change marker locations, within the defined region of interest. Again, the key point marker locations correspond to, are in particular identical to, virtual road sign locations. In subsequent step 706 the predicted key point marker locations computed by the deep neural network in step 705 may be stored to a database.

1. A computer-implemented method for predicting virtual road sign locations for virtual road signs comprising
collecting, as a first training data subset, one or more aerial and/or satellite images of a pre-determined region;
obtaining, as a second training data subset, geocentric positions of key point markers for key points in the pre-determined region;
supplying the first training data subset and the second training data subset to a deep neural network as training dataset;
training the deep neural network on the training dataset to predict key point marker locations in a region of interest, the key point marker locations corresponding to virtual road sign locations;
defining-a the region of interest as input dataset; and
processing the input dataset by the trained deep neural network to predict key point marker locations within the defined region of interest, the key point marker locations corresponding to virtual road sign locations.

2. The computer-implemented method of claim 1, wherein the predicted key point marker locations are stored in a database.

3. The computer-implemented method of claim 1, wherein the key points include at least one of turn points and line-changes.

4. The computer-implemented method of claim 1, wherein the deep neural network is a convolutional neural network.

5. The computer-implemented method of claim 1, wherein the geocentric positions of the key points markers are obtained through at least one of user input and one or more crowd sourcing platforms.

6. The computer-implemented method of claim 1, wherein the deep neural network predicts the key point marker locations such that, for an intersection, the key point markers are located ata center of each road or lane entering the intersection.

7. The computer-implemented method of claim 1, wherein the deep neural network predicts a key point marker location such that a corresponding key point marker can be easily perceived when superimposed onto environmental data.

8. The computer-implemented method of claim 1, wherein the input dataset is supplied to and processed by the deep neural network in an offline modus.

9. The computer-implemented method of claim 1, wherein the first training data subset is supplied to a second neural network as input data, further compromising:
detecting, by the second neural network, intersections in the first training data subset; and
checking, by the second neural network, whether the key point marker locations predicted by the trained deep neural network coincide with the detected intersections.

10. The computer-implemented method of claim 1, wherein the input dataset is supplied to and processed by the trained deep neural network in real-time by a mobile device provided in a vehicle during travel.

11. The computer-implemented method of claim 1, further compromising:
superimposing the virtual road signs at the predicted key point marker locations onto environmental data displayed to a driver of a vehicle.

12. (canceled)
